(19) United States
(12) Patent Application Publication
(10) Pub. No.: US 2014/0010503 A1
(43) Pub. Date: Jan. 9, 2014

(54) FIBER OPTIC CABLE

(71) Applicants: Yoshio Hashimoto, Greer, SC (US); Joseph Cignarale, Greer, SC (US); Matsuhiro Miyamoto, Greenville, SC (US)

(72) Inventors: Yoshio Hashimoto, Greer, SC (US); Joseph Cignarale, Greer, SC (US); Matsuhiro Miyamoto, Greenville, SC (US)

(73) Assignee: AFL TELECOMMUNICATIONS LLC, Duncan, SC (US)

(21) Appl. No.: 14/005,861

(22) PCT Filed: Mar. 20, 2012
(86) PCT No.: PCT/US12/29763

§ 371 Date: Sep. 18, 2013

Related U.S. Application Data
(60) Provisional application No. 61/466,716, filed on Mar. 23, 2011.

(51) Int. Cl. G02B 6/44

(52) U.S. Cl. CPC G02B 6/4401
USPC 385/100

(57) ABSTRACT

A fiber optic cable comprises at least one elongated optical fiber situated in a fiber nest having a plurality of filaments collectively surrounding the optical fiber. The cable further includes a structural member at least partially surrounding the optical fiber but spaced apart from the optical fiber in a radial direction such that at least some of the filaments of the fiber nest are positioned between the optical fiber and the structural member. The foregoing elements are encased in an outer jacket.

### BACKGROUND OF THE INVENTION

The present invention relates generally to fiber optic cable. More particularly, the present invention relates to an improved fiber optic cable that is well-suited for retrofit use in residential applications and the like.

The ability of high-quality optical fiber to transmit large amounts of information without appreciable signal degradation is well known. As a result, optical fibers have found widespread use in many applications, such as voice and data transmission. Initially, optical fiber was often limited to such uses as trunk line communications or commercial settings requiring high rates of data throughput. More recently, however, the need for greater bandwidth in residential settings has brought optical fibers directly into homes and multiple dwelling units (MDUs). Such applications have generally come to be known by the acronym FTTH (“Fiber To The Home”). As one skilled in the art will appreciate, retrofitting an existing structure with optical fiber can present various challenges not present when optical fiber is installed during construction.

Optical fiber is typically supplied and installed as fiber optic cable. The term “fiber optic cable” refers to the combination of the actual optical fiber plus the structure in which it is carried and protected during and after installation. Generally, a fiber optic cable includes the optical fiber, aramid fibers or other strength members, and an outer jacket. Two common types of fiber optic cable used in FTTH and similar applications are “simplex cable” and “flat type cable.”

Both simplex cable and flat type cable have certain advantages and disadvantages. Simplex cable, with a diameter generally about 3.0 millimeters, will not fit through some tight spaces. Furthermore, simplex cable has good flexibility—which is advantageous in some situations but can lead to difficulties in other situations. For example, the flexibility of simplex cable allows easy installation inside walls. This flexibility, however, makes it difficult for the installer to push simplex cable through conduit.

Flat type cable, which has two strength members of aramid fiber reinforced polymer (FRP) located on lateral sides of the optical fiber, exhibits better stiffness than simplex cable. As a result, it can be more easily pushed through conduit. With a width of only about 2.0 millimeters, flat type cable is also smaller than typical simplex cable. This allows it to be inserted into gaps and other openings through which a simplex cable might not fit. The two strength members also prevent excessive signal attenuation at low temperatures or due to bending. As disadvantages, flat type cable has a limited bend radius and does not easily bend in the side-to-side direction. As a result, great care must be taken when installing flat type cable into a wall.

The present invention recognizes the foregoing considerations, and others, of the prior art.

### SUMMARY OF THE INVENTION

According to one aspect, the present invention provides a fiber optic cable comprising at least one elongated optical fiber. A fiber nest having a plurality of filaments collectively surrounding the optical fiber is also provided. The cable further includes a structural member at least partially surrounding the optical fiber but spaced apart from the optical fiber in a radial direction such that at least some of the filaments of the fiber nest are positioned between the optical fiber and the structural member. The foregoing elements are encased in an outer jacket.

In exemplary embodiments, the structural member comprises a fiber reinforced polymer member. Fibers of the fiber reinforced polymer member and the fiber nest may be of the same fiber type, such as aramid fibers. The structural member may completely surround the optical fiber or partially surround the optical fiber in various embodiments. Where the structural member partially surrounds the optical fiber, it may have a C-shaped configuration.

To facilitate bending in any direction, the outer jacket is preferably configured to have a substantially round outer periphery. Also, the outer jacket is preferably sized so that the cable will fit into small holes and other tight spaces. For example, the outer jacket may preferably have a diameter no greater than about 1.8 millimeters. The outer jacket is also preferably provided with at least one inwardly-directed notch configured to facilitate removal of the outer jacket. In this regard, a pair of inwardly-directed notches situated at opposing locations on the outer jacket may be provided.

According to another aspect, the present invention provides a fiber optic cable comprising at least one elongated optical fiber. A structural member formed of fiber reinforced polymer and at least partially surrounding the optical fiber is also provided. The structural member is spaced apart from the optical fiber in a radial direction such that the optical fiber can move within the structural member. In addition, a fiber nest formed of a plurality of filaments collectively surrounding the optical fiber may be provided. At least some of the filaments in such embodiments are positioned between the optical fiber and the structural member. The cable further includes an outer jacket having a substantially round outer periphery.

In exemplary embodiments, the structural member may comprise a plurality of aramid fibers interconnected by a reinforcing resin. For example, the reinforcing resin may be selected from a group consisting of epoxy, thermal cure silicone resin and UV-cure urethane resin.

A further aspect of the present invention provides a method of making a fiber optic cable. According to one step of the method, an elongated optical fiber is provided. The optical fiber is situated in a fiber nest having a plurality of individual filaments. According to another step, a reinforcing resin is infused into an outer part of the fiber nest. The reinforcing resin is then processed to become hardened. As a result, a combination in which a structural member of fiber reinforced polymer is formed from the outer part of the fiber nest is produced. In addition, an outer jacket may be formed to encase the combination.

Another aspect of the present invention provides a fiber optic cable comprising at least one elongated optical fiber. A fiber nest having a plurality of aramid filaments collectively surrounding the optical fiber is also provided. The fiber optic cable according to this aspect of the present invention also comprises a structural member formed of a plurality of aramid fibers interconnected by a reinforcing resin. The structural member at least partially surrounds the optical fiber but is spaced apart from the optical fiber in a radial direction such that at least some of the filaments of the fiber nest are positioned between the optical fiber and the structural member. The fiber optic cable further includes an outer jacket having a substantially round outer periphery of a diameter of no greater than about 1.8 millimeters.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a transverse cross-sectional view of a fiber optic simplex cable in accordance with the prior art;

FIG. 2 is a perspective view of the prior art cable of FIG. 1 with layers cut away;

FIG. 3 is a transverse cross-sectional view of a flat type fiber optic cable in accordance with the prior art;

FIG. 4 is a perspective view of the prior art cable of FIG. 3 with jacket halves separated;

FIG. 5 is a transverse cross-sectional view of a fiber optic cable in accordance with an embodiment of the present invention;

FIG. 6 is a perspective view of the cable of FIG. 5 with jacket halves separated;

FIG. 7 illustrates a wiring conduit of an existing building structure through which a fiber optic cable of the present invention is being pushed;

FIG. 8 is an enlarged fragmentary view showing a portion of a fiber optic cable constructed in accordance with an embodiment of the present invention;

FIG. 9 is a diagrammatic representation of an exemplary process for making the cable of FIG. 8;

FIG. 10 is a transverse cross-sectional view of a fiber optic cable in accordance with a further embodiment of the present invention; and

FIG. 11 is a perspective view of the cable of FIG. 10 with the outer jacket partially cut away to better show certain internal details.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

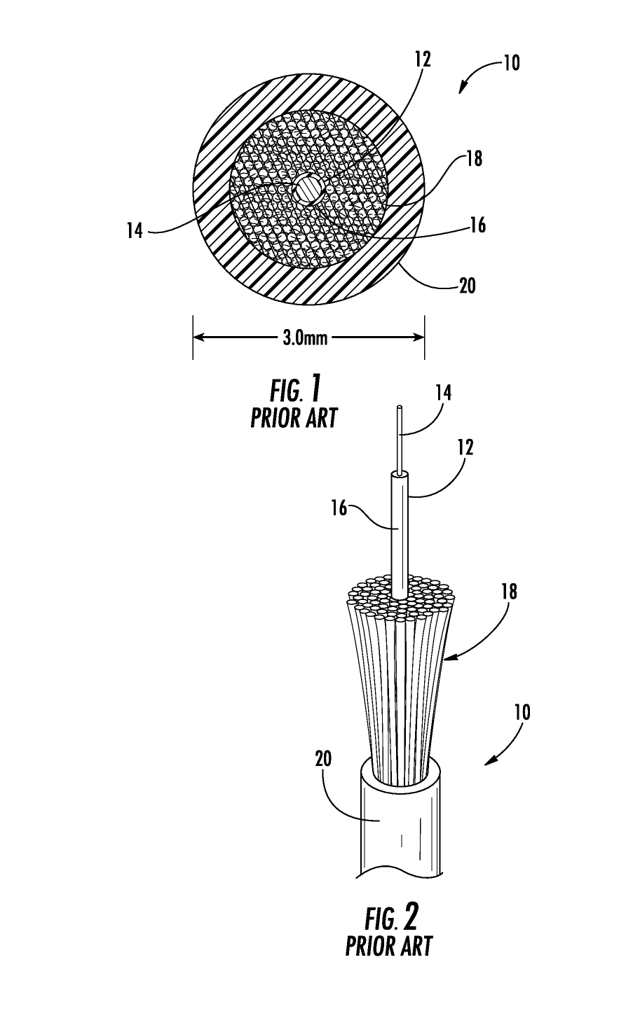

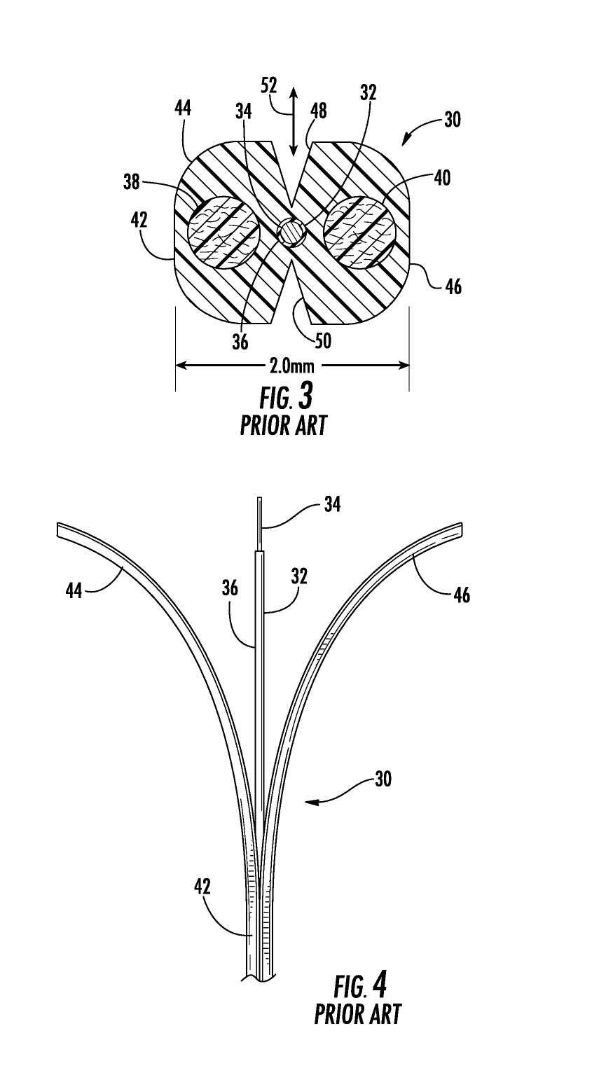

Before turning to preferred embodiments of the present invention, certain additional aspects of the prior art will be described in greater detail. In this regard, FIGS. 1 and 2 illustrate a simplex cable 10 in accordance with the prior art. As shown, cable 10 includes an optical fiber unit 12 extending along its central axis. Optical fiber unit 12 comprises a glass fiber 14 for the transmission of optical signals. A protective sheath 16 is located around the glass fiber 14, as shown. Typically, sheath 16 will be formed of a fluoropolymer, such as PVC. As used herein, the term “optical fiber” is intended to be synonymous with the optical fiber unit including the glass fiber and sheath.

Optical fiber unit 12 is located at the center of a yarn 18 formed of a plurality of loose aramid fibers, as shown. The aramid fibers provide strength to the overall cable 10. Yarn 18 and optical fiber unit 12 are encased by an outer jacket 20. The outer jacket is made of a material such as plenum-rated PVC, riser-rated PVC or LSZH.

As noted above, simplex cable provides good flexibility which is advantageous in some situations. The flexibility of simplex cable is often a disadvantage, however, because it cannot be effectively pushed through long conduits. In addition, the diameter of some simplex cable (typically 3.0 millimeters) prevents it from being used in some installations where space is very limited.

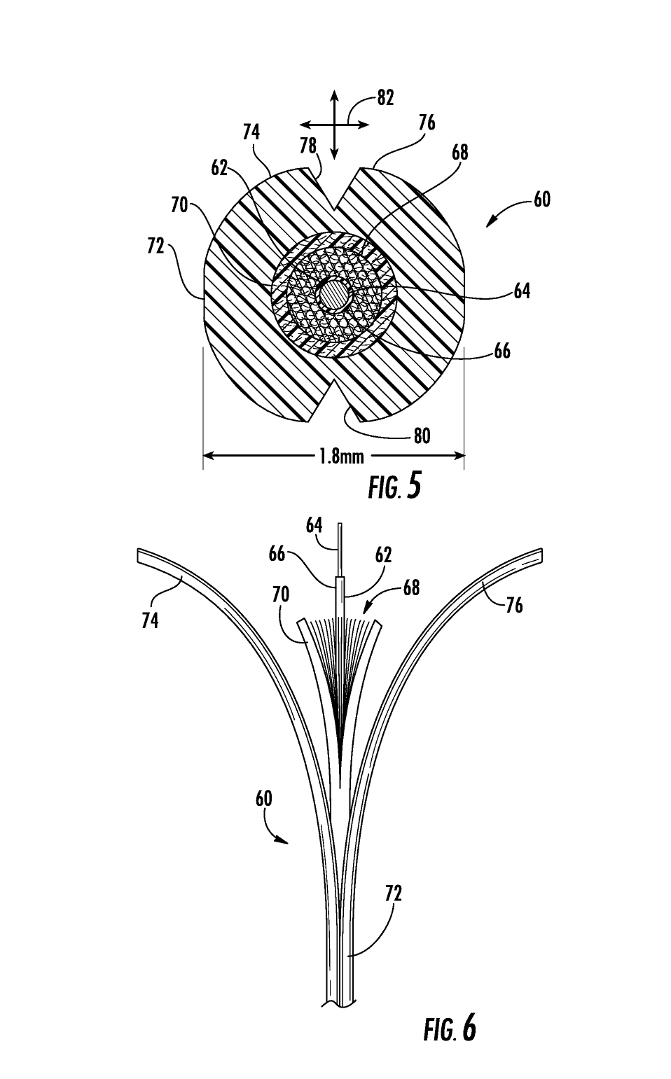

Turning now to FIGS. 3 and 4, a typical flat type cable 30 in accordance with the prior art is illustrated. As can be seen, cable 30 has an optical fiber unit 32 extending along its central axis. Optical fiber unit 32 includes a glass fiber 34 and a sheath 36 similar to that described above in connection with simplex cable 10. Unlike simplex cable 10, however, flat type cable 30 includes a pair of strength members 38 and 40 running alongside optical fiber unit 32. Strength members 38 and 40 are formed of fiber reinforced polymer (FRP) made by infusing aramid yarn with a hardening polymer, such as epoxy. Strength members 38 and 40 thus add rigidity to cable 30.

Cable 30 is encased in an outer jacket 42 which may be typically formed of FR-PE (flame resistant polyethylene) material. FR-PE is typically used as an outer jacket of this type of drop cable in Japan and in other Asian regions in order that the cable meets regional standards (e.g. Japanese Industrial Standard C3005 in Japan). As can be seen, outer jacket 42 in this embodiment is configured having a first half portion 44 and a second half portion 46 defined by inwardly-directed notches 48 and 50. As illustrated in FIG. 4, notches 48 and 50 allow jacket 42 to be opened in zipper-like fashion in order to access optical fiber unit 32 for termination.

As discussed above, flat type fiber optic cable has several desirable qualities. In particular, the presence of strength members 38 and 40 allows it to be pushed through existing conduit. In addition, the relatively small 2.0 millimeter width of typical flat type cable is smaller than the diameter of typical simplex cable. As a result, flat type cable can often be fit into tighter spaces than is the case with simplex cable. However, one significant drawback of flat type cable in some installations is its bending capability. In particular, flat type cable 30 is generally limited to bending in the top-to-bottom direction (indicated by arrow 52). The shape and location of strength members 38 and 40 make side-to-side bending very difficult. As a result, there are some situations where the use of flat type cable is not feasible.

Preferred embodiments of a fiber optic cable constructed in accordance with the present invention will now be described. As will become apparent from the ensuing discussion, fiber optic cables of the present invention provide numerous advantages in comparison with various cables of the prior art. In this regard, fiber optic cables of the present invention will typically exhibit good stiffness to facilitate pushing of the cable into conduits. In addition, the cables will effectively bend in most any direction, thus facilitating installation in both walls and conduits. Preferred embodiments also have smaller diameter than many conventional cables, thus allowing installation in small holes and other tight spaces. Moreover, the optical fiber unit in the interior of the cable is well protected such that there is minimal signal attenuation due to bending or low temperatures.

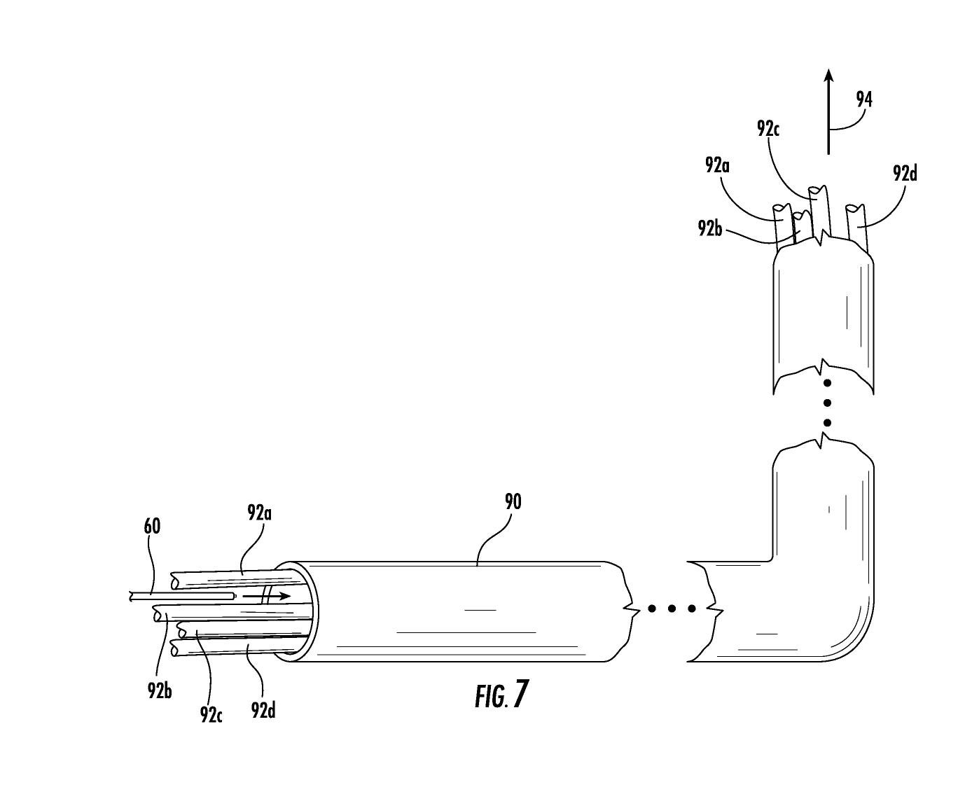

Referring now to FIGS. 5 and 6, a fiber optic cable 60 constructed in accordance with a first embodiment of the present invention is illustrated. As shown, fiber optic cable 60 includes an optical fiber unit 62 extending along its central axis. Optical fiber unit 62 includes a glass fiber 64 encased in a sheath 66.

Optical fiber unit 62 is located at the approximate center of a “fiber nest” 68 formed by a plurality of loose aramid fibers (filaments). As used herein, the term “loose” indicates that the filaments are not interconnected with one another using a reinforcing polymer. Instead, the individual filaments may be tightly packed, but are capable of independent movement.

As explained in more detail below, the fiber nest may be formed of a multifilament yarn into which the optical fiber is inserted. In this regard, the filaments of the yarn may be formed of any suitable synthetic or inorganic material. For example, the filaments in presently preferred embodiments may be aramid. The aramid yarn may have an overall size of about 4800 denier, with an 8×600 denier construction. However, it is contemplated that 400 denier, 600 denier, 1000 denier and 1420 denier yarns may also be used in some embodiments. For example, embodiments are contemplated in which twelve 400 denier yarns, or combinations of yarns having different deniers, are used. One skilled in the art will appreciate, however, that the size of the yarn and filaments, as well as the number of filaments making up the yarn, can be varied depending on tensile strength requirements. Embodiments are also contemplated in which the filaments may be glass fibers.

Radially outside of fiber nest 68 is a structural member 70. In this case, structural member 70 is formed in the configuration of a tube surrounding fiber nest 68 and optical fiber unit 62. For example, structural member 70 may have an outer diameter of no more than about 0.8 millimeters in many preferred embodiments. As a result of this configuration, optical fiber unit 62 is capable of some movement within structural member 70.

Preferably, structural member 70 may be formed of fiber reinforced polymer (FRP). For example, aramid filaments may be infused with a reinforcing polymer and then hardened to yield structural member 70. Any suitable polymer may be utilized for this purpose, including epoxy, thermal cure silicone resin, and UV-cure urethane resin. The presence of structural member 70 provides sufficient rigidity so that cable 60 can be easily pushed through wiring conduit. Structural member 70 also prevents shrinking under low temperature and otherwise protects optical fiber unit 62.

Structural member 70 and the components internal to it may be encased in a suitable outer jacket 72. Preferably, outer jacket 72 may be formed of plenum-rated PVC, riser-rated PVC or LSZH material. The specific choice of material will often depend on the needs of the purchaser. As shown, outer jacket 72 comprises a first half portion 74 and a second half portion 76 defined by a pair of oppositely-directed notches 78 and 80. In the illustrated embodiment, jacket 72 has a generally circular outer periphery with a diameter of preferably no more than about 1.8 millimeters. The configuration of cable 60 allows it to bend without difficulty in any direction, as indicated by crossing arrows 82.

Referring now to FIG. 6, it can be seen that notches 78 and 80 allow half portions 74 and 76 to be easily separated by the installer. As a result, the end of cable 60 can be opened in zipper-like fashion to reveal structural member 70 and optical fiber unit 62. In this case, structural member 70 can be opened in any suitable manner. Because optical fiber unit 62 is carried inside of fiber nest 68, it is easy to locate and remove after structural member 70 is opened.

Installation of fiber optic cable 60 through wiring conduit 90 of a building is shown in FIG. 7. As is typical, wiring conduit 90 may have a plurality of existing wires or cables 92a-d located therein. Cables 92a-d may include telephone cables, coax cables, network cables or the like. In many cases, some of the existing cables may no longer be in use. Nevertheless, their presence in wiring conduit 90 limits the amount of available space into which fiber optic cable 60 can be inserted. Because of its characteristics, however, fiber optic cable 60 can be pushed through conduit 90 until it exits, as indicated at arrow 94. In other words, fiber optic cable 60 will thus effectively traverse the entire length of the conduit.

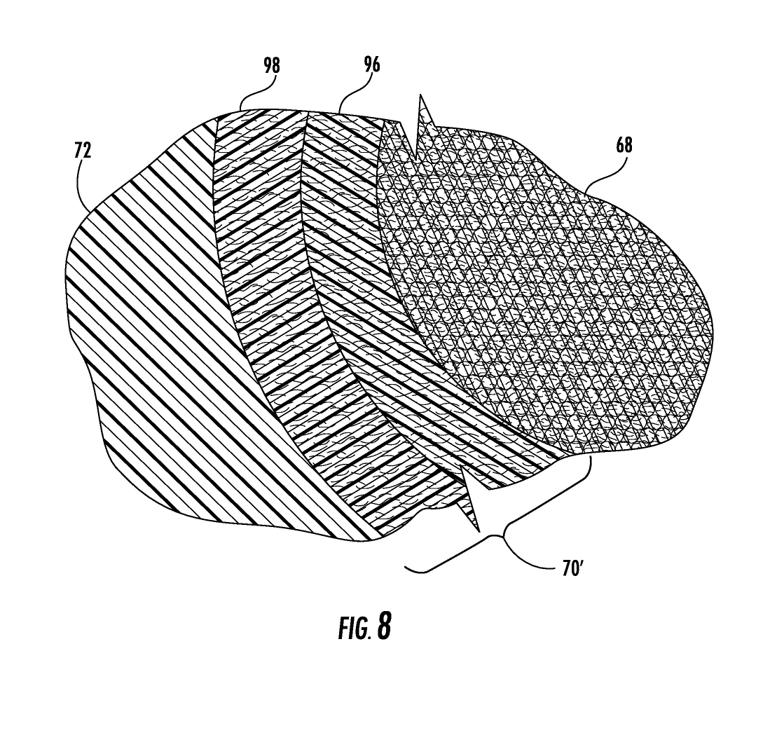

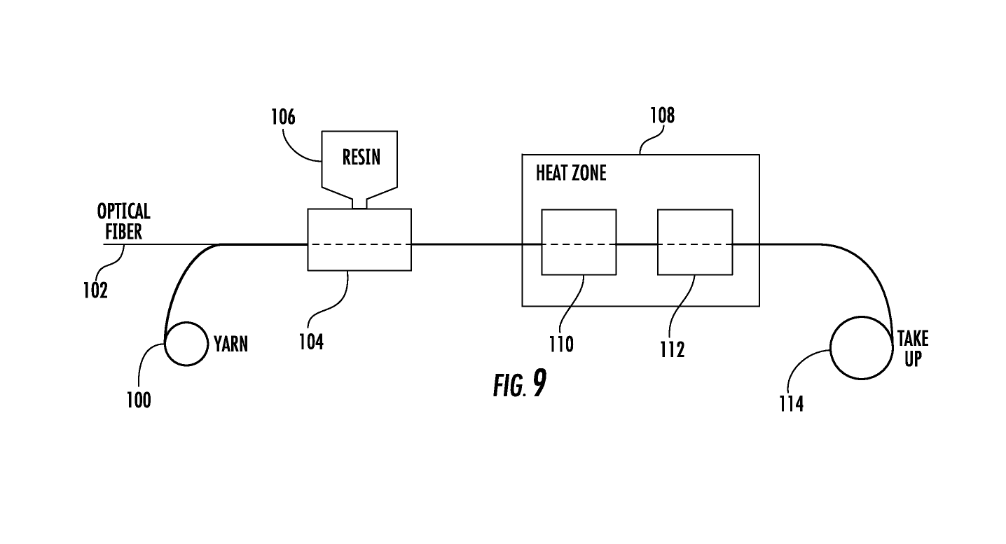

In some embodiments, it is contemplated that the structural member may comprise multiple layer-like portions. As shown in FIG. 8, for example, structural member 70′ is configured having an inner layer portion 96 and an outer layer portion 98. Inner layer portion 96 may comprise a mixture of dry aramid filaments and resin-penetrated aramid filaments. As a result, portion 96 will be a bit “harder” than the loose filaments in fiber nest 68. On the other hand, the interstices of the aramid filaments of outer layer portion 98 are fully penetrated by the epoxy. This will provide a harder outer shell to the assembly of components inside of the outer jacket. One skilled in the art will appreciate that the boundary between layer portions 96 and 98 may or may not be gradual depending on the manner in which structural member 70′ is made.

FIG. 9 illustrates an exemplary process which may be used to manufacture a fiber optic cable such as that illustrated in FIG. 8. In this case, multifilament aramid yarn is fed from a first spool located at position 100. As indicated at 102, optical fiber is fed such that it will be located along the central axis of the yarn. The resulting combination passes through an infusing station 104 where a suitable resin 106 is applied. Variables such as viscosity, pressure and dwell time can be used to control the penetration of resin into the yarn. As a result, the outermost filaments will be completely infused whereas the innermost filaments will not be infused at all. Those filaments located in between will be partially infused.

After passing from infusing station 104, the yarn enters a curing zone 108 where the resin is set or otherwise cured. In this case, curing zone 108 includes a pair of ovens 110 and 112 which provide heat for curing. Where a resin other than thermoset is used, such as a UV-cured resin, one skilled in the art will appreciate that curing zone 108 may comprise other types of suitable equipment.

After the resin is cured, the resulting combination may be taken up on another spool, as indicated at 114. Thus, in this example, the outer jacket is applied later in a separate process. One skilled in the art, however, will appreciate that a continuous process may also be utilized in which the outer jacket is applied immediately after curing zone 108 (and thus before take up).

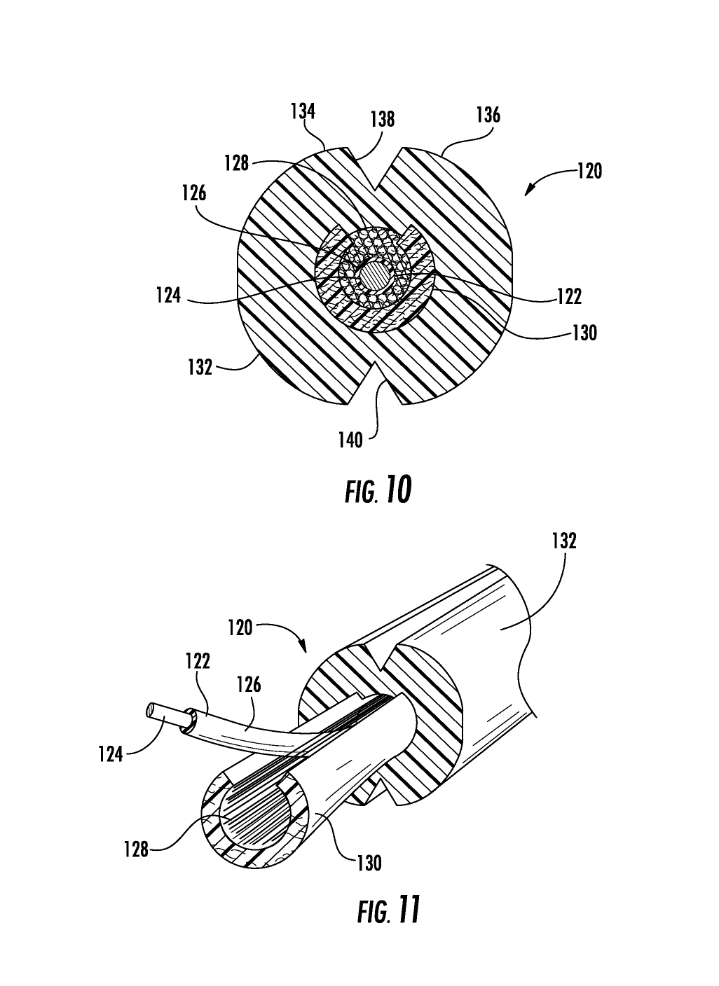

FIGS. 10 and 11 show a fiber optic cable 120 constructed in accordance with an alternative embodiment of the present invention. As can be seen, fiber optic cable 120 includes an optical fiber unit 122 extending along its central axis. Optical fiber unit 122 includes a glass fiber 124 encased with a sheath 126. Optical fiber unit 122 is located at the axial center of a fiber nest 128 comprising a plurality of loose filaments formed of a suitable fiber material, such as aramid. Optical fiber unit 122 and fiber nest 128 are preferably similar to their counterparts previously described in connection with fiber optic cable 60.

In this embodiment, a structural member 130 is provided having a C-shaped configuration. As can be seen, the part of fiber nest 128 located inside of structural member 130 will serve to support optical fiber unit 122 and maintain it in position. Like the embodiment described above, the loose filaments of fiber nest 128 will allow some adjusting movement of optical fiber unit 122 as cable 120 is bent.

Preferably, structural member 130 may be formed of FRP such as aramid fibers reinforced with a suitable hardening resin. Examples of suitable resins are epoxies, thermal cure silicone resins, or UV-cure urethane resins. One skilled in the art will appreciate that it may be necessary to produce structural member 130 in this embodiment in a separate process, and then join it with loose aramid yarn and the optical fiber unit.

Fiber optic cable 120 further includes an outer jacket 132 formed of any suitable material, such as plenum-rated PVC, riser-rated PVC or LSZH material. Again, the specific choice of material will often depend on the needs of the purchaser. As shown, outer jacket 132 comprises half portions 134 and 136 defined by oppositely-directed notches 138 and 140. Notches 138 and 140 allow half portion 134 and half portion 136 to be separated easily by the installer such that outer jacket 132 is opened in zipper-like fashion. As can be seen, jacket 132 defines a substantially circular outer periphery in this embodiment. The diameter of cable 120 may be small, such as no greater than about 1.8 millimeters.

Generally, fiber optic cable 120 will have the same desirable characteristics of bendability plus rigidity that are present in fiber optic cable 60. In addition, the shape of structural member 130 may provide an additional advantage during use. Specifically, as can be seen in FIG. 11, the longitudinal opening in structural member 130 allows the installer to easily locate and remove optical fiber unit 122 without cutting structural member 130. As a result, there is little chance that optical fiber unit 122 may be inadvertently cut by the installer.

It can thus be seen that the present invention provides an improved fiber optic cable having various advantages in comparison with the prior art. While preferred embodiments of the invention have been shown and described, modifications and variations may be made thereto by those of ordinary skill in the art without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. A fiber optic cable comprising:
at least one elongated optical fiber;
a fiber nest having a plurality of filaments collectively surrounding said optical fiber;
a structural member having an arcuate shape and partially surrounding said optical fiber, said structural member being spaced apart from said optical fiber in a radial direction such that at least some of said filaments of said fiber nest are positioned between said optical fiber and said structural member; and
an outer jacket.

2. A fiber optic cable as set forth in claim 1, wherein said structural member comprises a fiber reinforced polymer member.

3. A fiber optic cable as set forth in claim 2, wherein fibers of said fiber reinforced polymer member and said plurality of filaments of said fiber nest are of a same fiber type.

4. A fiber optic cable as set forth in claim 3, wherein said fiber reinforced polymer member and said plurality of filaments of said fiber nest comprise aramid fibers.

5. A fiber optic cable as set forth in claim 3, wherein said fiber reinforced polymer member and said plurality of filaments of said fiber nest comprise glass fibers.

6. A fiber optic cable as set forth in claim 1, wherein said structural member has a C-shaped configuration.

7. A fiber optic cable as set forth in claim 1, wherein said outer jacket has a substantially round outer periphery.

8. A fiber optic cable as set forth in claim 7, wherein said outer jacket has an outer diameter of no greater than 1.8 millimeters.

9. A fiber optic cable as set forth in claim 7, wherein said outer jacket comprises at least one inwardly-directed notch configured to facilitate removal of said outer jacket.

10. A fiber optic cable as set forth in claim 7, wherein outer jacket has a pair of said inwardly-directed notches situated at opposing locations.

11. A fiber optic cable comprising:
at least one elongated optical fiber;
a structural member formed of fiber reinforced polymer and at least partially surrounding said optical fiber, said structural member being spaced apart from said optical fiber in a radial direction such that said optical fiber can move within said structural member; and
an outer jacket having a substantially round outer periphery and defining at least one inwardly-directed notch configured to facilitate removal of said outer jacket.

12. A fiber optic cable as set forth in claim 11, wherein said structural member comprises a plurality of aramid fibers interconnected by a reinforcing resin.

13. A fiber optic cable as set forth in claim 12, wherein said reinforcing resin is selected from a group consisting of epoxy, thermal cure silicone resin and UV-cure urethane resin.

14. A fiber optic cable as set forth in claim 11, further comprising a fiber nest formed of a plurality of filaments collectively surrounding said optical fiber, at least some of said filaments being positioned between said optical fiber and said structural member.

15. A fiber optic cable as set forth in claim 14, wherein said filaments of said fiber nest comprise aramid fibers.

16. A fiber optic cable as set forth in claim 11, wherein said structural member completely surrounds said optical fiber.

17. A fiber optic cable as set forth in claim 16, wherein said structural member has a partially-infused inner layer portion and a fully-infused outer layer portion.

18. A fiber optic cable as set forth in claim 11, wherein said structural member has an arcuate shape and partially surrounds said optical fiber.

19. A fiber optic cable as set forth in claim 18, wherein said structural member has a C-shaped configuration.

20. A fiber optic cable as set forth in claim 11, wherein said outer jacket has an outer diameter of no greater than 1.8 millimeters.

21. A fiber optic cable comprising:
at least one elongated optical fiber;
a fiber nest having a plurality of aramid filaments collectively surrounding said optical fiber;
a structural member formed of a plurality of aramid fibers interconnected by a reinforcing resin;
said structural member having a C-shaped configuration and surrounding said optical fiber but being spaced apart from said optical fiber in a radial direction such that at least some of said filaments of said fiber nest are positioned between said optical fiber and said structural member; and
an outer jacket having a substantially round outer periphery of a diameter of no greater than 1.8 millimeters.

22. A fiber optic cable as set forth in claim 21, wherein said reinforcing resin is selected from a group consisting of epoxy, thermal cure silicone resin and UV-cure urethane resin.
